(19) United States
(12) Patent Application Publication
(10) Pub. No.: US 2022/0275236 A1
(43) Pub. Date: Sep. 1, 2022

(54) AQUEOUS PIGMENT PREPARATIONS AND THEIR USE IN TINTING SYSTEMS AND FOR DYEING COATING AGENTS

(71) Applicant: CLARIANT INTERNATIONAL LTD, Muttenz (CH)

(72) Inventors: Benjamin SCHEINHARDT, Frankfurt (DE); Uwe BECHTOLD, Dietzenbach (DE); Dorothee GABEL, Wiesbaden (DE); Felix HOEVELMANN, Mühldorf (DE); Rainer KUPFER, Hattersheim (DE)

(73) Assignee: CLARIANT INTERNATIONAL LTD, Muttenz (CH)

(21) Appl. No.: 17/626,921

(22) PCT Filed: Jul. 9, 2020
(86) PCT No.: PCT/EP2020/069374

§ 371 Date: Jan. 13, 2022

(30) Foreign Application Priority Data
Jul. 16, 2019 (DE) 10 2019 210 457.6

(51) Int. Cl. C09D 17/00; C09D 7/45; C09B 67/46; C09D 11/037; C09D 11/322

(52) U.S. Cl. CPC C09D 17/001; C09D 7/45; C09B 67/009; C09D 11/037; C09D 11/322

(57) ABSTRACT

Aqueous pigment preparations contain at least one organic and/or inorganic pigment and/or filler, at least one dispersant of formula (I) or (II), or mixtures of dispersants of formulae (I) and (II), wherein n is an integer ≥1, z is an integer ≥1, R1 is an aliphatic, linear or branched hydrocarbon radical with 1 to 30 carbon atoms or a hydrogen atom or the structural unit —O—X or the structural unit CH₂—O—X, and the structural unit X of formula (III), wherein a is an integer from 1 to 50, b is an integer from 0 to 50, c is an integer from 1 to 100, m is an integer from 1 to 50, R2 is an aliphatic, linear or branched hydrocarbon radical with 1 to 30 carbon atoms, Y is hydrogen, SO₃M, —SO₂M, —PO₃M₂, —CH₂COOM and M is hydrogen or a cation. Additional additives may be present.

Subject-matter of the present invention are aqueous pigment preparations and dispersions and also their use for tinting systems and for coloring coating materials, binder systems, paints, renders, varnishes and inks of all kinds.

Aqueous or solvent borne coating materials, binder systems, paints, varnishes and inks, in the architectural paints segment, for example, are oftentimes colored using ready-made pigment preparations. Pigment preparations are liquid compositions in which the pigment is present in fine division in a continuous medium. Aqueous pigment preparations, in which water is used as the continuous medium, have taken up a dominant position, or are preferred, over solvent-based pigment preparations in numerous areas of application. Examples of reasons for this are regulatory provisions and also the guidelines for the awarding of modern environmental labels, such as the Blue Angel or the European eco-label, which are increasingly limiting the use of volatile organic compounds (VOCs), in numerous application media and hence also ultimately in the pigment preparations that are used.

Pigments are commonly dispersed using surface-active substances, such as wetting and dispersing assistants, which promote pigment wetting and physically stabilize the pigment particles in their finely divided form in the continuous medium. These assistants may be nonionic, anionic, cationic or amphoteric in nature and may also have surfactant or macromolecular character. The properties of a pigment preparation are critically influenced by the dispersants it contains.

Pigment preparations are commonly used as coloring components in tinting systems, also called paint mixing systems. Here, the coloring of what is called a tinting base, which may be in white or transparent or chromatic form and which may comprise liquid binder systems of any kind, is achieved by software-controlled metering of one or a combination of different pigment preparations. It is commonly employed, for example, in in-plant tinting for the manufacture of substantial quantities of one shade. In many cases, tinting of the tinting base only at the point of sale is more economic, since in this case the user can be provided with a great diversity of color shades, without these having to be stocked in substantial quantities. In this case the pigment preparations are commonly metered using tinting machines which are set up at the point of sale.

For use in tinting systems, pigment preparations are required to have a suitable rheological profile, in order to ensure sufficient pumpability and meterability. High metering accuracy is needed in order to prevent or to minimize deviations from the target shade. This is especially the case for use in tinting machines in the point-of-sale segment, where even very small volumes of <0.1 mL must be accurately metered. Many pigment preparations are nonnewtonian fluids, meaning that their viscosity is dependent on the shearing forces acting on them. Typically a viscosity of <10 Pa*s at a shear rate of 5 s⁻¹ and <3 Pa*s at a shear rate of 30 s⁻¹, along with very low thixotropy and rheopexy, are needed in order to achieve the required pumpability and meterability. This rheological behavior must at the same time be retained in a broad temperature range of typically 5-40° C. over a prolonged period of >1 year, even under the significant stresses which frequently act on the pigment preparations in these applications, such as by repeated and intensive stirring or pumping, for example. For pigment preparations with a high pigment content of >30 wt %, this is a very great technical challenge, and requires dispersants featuring outstanding viscosity reduction and stabilization effect. Pigment contents as high as possible are very often preferred on technical grounds, in order, for example, to minimize the amount of a pigment preparation that has to be added to the tinting base in order to achieve a particular shade, and hence to minimize any unwanted change in the properties of the tinting base, and often also offer economic and environmental benefits.

The pigment preparations must be stable under shear, at elevated temperature, and under pressure variation, when being pumped, metering through nozzles, applied by spraying, or undergoing degassing/deaerating, for example.

The aforesaid applications require pigment preparations with low foaming propensity, in order to prevent foaming or any change in the density. For application in tinting machines, this is essential, since the pigment preparations are commonly metered volumetrically and any change in the density can lead to a deviation from the target shade. Because the foaming propensity of the pigment preparations is critically determined by the dispersants used, suitable low-foam dispersants are needed.

For use in tinting systems, the pigment preparations have to be compatible with a multiplicity of different tinting bases and binder systems, with compatibility meaning that they must be able to be incorporated simply and efficiently therein without flocculation or reaggregation of the pigment particles, in any proportions. In the case of so-called universal pigment preparations, they are required to be compatible with both aqueous and solvent borne application systems. The compatibility of a pigment preparation with the application medium is critically determined via the dispersants used. The multiplicity of binder systems available on the market, with a very wide variety of different compositions, poses a major challenge and requires pigment preparations having a broad compatibility.

A common requirement for the coloring of coating materials is that the pigment preparations used do not adversely affect the profile of properties of said materials. For example, the pigment preparations must not give rise to any surface defects, such as craters, in the dried film, or alter the drying behavior or the water absorption. This is critically influenced by the dispersants that are used in the pigment preparations. In the case of masonry paints, surface effects, such as running tracks or instances of leaching (referred to as snail trails), which may be brought about after weathering by dew, mist, water splashes or rain, because of water-soluble ingredients, such as surfactants or dispersants, for example, are very much unwanted. Polymers or relatively high molecular mass dispersants have a lower tendency to form such unwanted surface effects.

A common requirement imposed on tinting systems is the ability to formulate a large number of often >1000 color shades. This presupposes that the pigment preparations used are compatible with one another and readily miscible in any proportions. This can be achieved, for example, by the pigment preparations that are used for the tinting system being based on the same dispersant. For this purpose, dispersants are needed that are suitable for a multiplicity of different organic and inorganic pigments and that permit the production of corresponding pigment preparations having the aforesaid properties. For the industrial production of these pigment preparations, the use of one dispersant for a multiplicity of different pigments likewise affords great advantages, in terms of logistics, stock-holding and complexity, for example, and is therefore desirable.

In view of the different properties of the various pigments, this poses a particular challenge for the dispersant. For example, the surface polarity of different pigments may differ greatly, so making it hard to achieve sufficient affinity between the dispersant and a multiplicity of different pigment surfaces, and hence a sufficient viscosity reduction and particle stabilization effect for the various pigments. Similarly, different pigments may differ greatly in their particle sizes and particle morphologies. A dispersant which is to be equally suitable for a multiplicity of different pigments must therefore have the ability to stabilize, equally, both comparatively small-particle and large pigment particles. The provision of one dispersant which is equally suitable for organic pigments, for inorganic pigments and for carbon blacks therefore poses a major challenge.

Continual bolstering of regulatory provisions or eco-label awarding guidelines is ensuring that, increasingly, customary formulating components for pigment preparations can no longer be used, or now only to a limited degree, for some areas of application. Within the industry, for example, there is a strong trend toward limiting the use of conventional in-can preservatives, such as isothiazolinones, or to abandoning them entirely. Alternative approaches to nevertheless achieving a sufficient microbiological stability are often based on the establishment of an alkalinity which is sufficient for preservation. Therefore, dispersants are needed which are chemically stable even under alkaline pH values of >10 and at the same time retain sufficient particle stabilization and viscosity reduction.

For the same reason, there are nowadays stringent limitations on the selection of wetting agents and dispersants that can be used. For example, alkylphenol ethoxylates (APEOs) are nowadays strictly regulated, and prohibited for many applications, owing to the bioaccumulative and hormonally acting degradation products. While the use of tristyrylphenol ethoxylates (TSPEOs) continues to be an option, the adverse ecotoxicological profile means that there is a strong trend in the industry to abandon these raw materials. For the same reasons, there is successive limitation on the use of the novolac-based or bisphenol A-based dispersants that were used in the past. The use of reaction products based on primary and secondary amines as dispersants is also critical for some applications, for both regulatory and performance reasons, and is therefore limited as an option.

The provision of aqueous pigment preparations for the applications stated above, said preparations satisfying not only the exacting technical requirements but also the regulatory requirements, in terms of the toxicological and ecotoxicological profile, for example, is an increasing challenge to the industry and cannot be adequately resolved on the basis of the state of the art.

The prior art has described aqueous pigment preparations based on a variety of dispersing assistants.

EP 1 078 946 discloses aqueous pigment pastes based on block-copolymeric, styrene oxide-containing polyalkylene oxides as pigment wetting agents.

EP 1 805 270 describes waterborne pigment preparations based on oligo esters.

DE 10 2006 002 800 discloses aqueous pigment preparations based on copolymers of styrene oxide, alkylene oxides and difunctional or polyfunctional amines and also alcohols. Not described here, however, are pigment preparations having a profile of properties as needed for the aforesaid applications. For example, the necessary compatibility of the pigment preparations with a multiplicity of different binder systems was not recognized in this case. Because of regulatory and performance requirements, moreover, the use of amine-based dispersants in the aforesaid applications is often undesirable, so severely limiting the pigment preparations described in DE 10 2006 002 800. The viscosities disclosed for the pigment preparations are indeed within the desired range; however, the pigment contents described there and the associated color strengths of the pigment preparations are comparatively low, and the rheology and also the storage stability of the pigment preparations at the pigment contents needed for the abovementioned applications are not described. There is also no description of suitability for tinting systems, especially in the point-of-sale segment.

EP 2 147 066 describes aqueous pigment preparations based on nonionic copolymers which are prepared using macromonomers of polyethylene/polypropylene glycol mono(meth)acrylic esters.

The aqueous pigment preparations described in the prior art often fail to fulfil the toxicological and ecotoxicological profile that is required for the aforementioned applications. Furthermore, they frequently lack sufficient compatibility with different aqueous or solvent borne binder systems. Moreover, their rheological behavior and storage stability at the pigment contents required are often greatly in need of improvement.

There has been no description to date of aqueous pigment preparations which meet all of the conditions for the above-described applications without entailing disadvantages.

It was an object of the present invention, therefore, to provide aqueous pigment preparations which are toxicologically and ecotoxicologically flawless and are free from alkylphenol, tristyrylphenol, novolac and bisphenol A derivatives. The pigment preparations ought further to exhibit broad compatibility with one another and also with a multiplicity of different binder systems, and ought not to lead to any unwanted surface defects or effects in the application system. The aqueous pigment preparations ought to possess a high color strength, a low foaming tendency, and a suitable rheological profile at a very high pigment content, in order to permit sufficient meterability on standard commercial tinting machines. Furthermore, the preparations ought to be stable in storage and under shear; in other words, the properties described above ought also to be stably retained on storage over a prolonged period or under shear.

It has surprisingly been possible to achieve this object by dispersing the pigment with specific, below-defined nonionic or anionically modified copolymers of polyols with a hydricity of three or more, styrene oxide and alkylene oxides. Where other copolymers of styrene oxide and alkylene oxides are used, the resulting aqueous pigment preparations do not have the entire above-stated profile of properties, particularly in terms of the desired coloristic properties, pigment content, compatibility, rheology, foaming tendency, and stability.

A subject of the invention, therefore, are aqueous pigment preparations comprising

(A) at least one organic and/or inorganic pigment and/or filler

(B) at least one dispersant of the formula (I) or (II), or mixtures of the dispersants of the formulae (I) and (II),

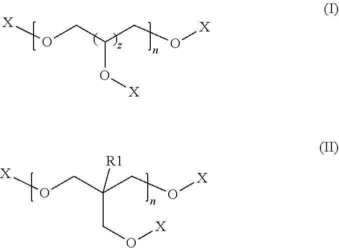

where

n is an integer greater than or equal to 1,

z is an integer greater than or equal to 1,

R1 is an aliphatic, linear or branched hydrocarbon radical having 1 to 30 carbon atoms, or a hydrogen atom, or the structural unit —O—X or the structural unit —CH₂—O—X,

and structural unit X corresponds to the formula (III)

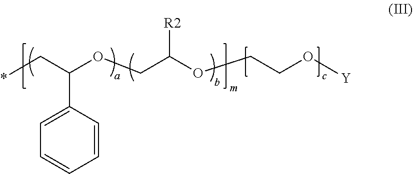

in which

a is an integer from 1 to 50, preferably 1 to 20, more preferably 1 to 10,

b is an integer from 0 to 50, preferably 0 to 20, more preferably 0 to 10,

c is an integer from 1 to 100, preferably 10 to 50,

m is an integer from 1 to 50, preferably 1 to 10,

R2 is an aliphatic, linear or branched hydrocarbon radical having 1 to 30 carbon atoms,

Y is hydrogen, —SO₃M, —SO₂M, —PO₃M₂, —CH₂COOM, and

M is hydrogen or a cation, preferably from the group of Na⁺, K⁺, NH₄⁺, triethanolammonium, or a combination thereof.

Further, the pigment preparation of the invention may also comprise the following further additives:

(C) optionally wetting agents,

(D) and/or optionally further surfactants and/or dispersants,

(E) and/or optionally one or more hydrotropic substances and/or one or more organic solvents and/or mixtures thereof,

(F) and/or optionally one or more binders and/or cobinders,

(G) and/or optionally further adjuvants customary for producing aqueous pigment dispersions, and

(H) water.

Preferred pigment preparations comprise 5 to 80 wt %, preferably 10 to 70 wt %, especially preferably 30 to 70 wt % of component (A).

Preferred pigment preparations comprise 0.1 to 30 wt %, preferably 2 to 20 wt %, especially preferably 5 to 15 wt % of component (B).

Particularly preferred pigment preparations comprise component

(A) at 5 to 80 wt %, more particularly 10 to 70 wt %,

(B) at 0.1 to 30 wt %, more particularly 2 to 20 wt %,

(C) at 0 to 10 wt %, more particularly 0.1 to 5 wt %,

(D) at 0 to 20 wt %, more particularly 1 to 10 wt %,

(E) at 0 to 30 wt %, more particularly 5 to 20 wt %,

(F) at 0 to 30 wt %, more particularly 1 to 10 wt %,

(G) at 0 to 20 wt %, more particularly 0.1 to 5 wt %,

(H) balance water,

based in each case on the total weight (100 wt %) of the pigment preparation.

Where the pigment preparation of the invention comprises one or more of components (C), (D), (E), (F) and (G), the minimum concentration thereof, independently of one another, is preferably at least 0.01 wt %, more particularly at least 0.1 wt %, based on the total weight of the pigment preparation.

Component (A) of the pigment preparation of the invention is a finely divided organic or inorganic pigment or a filler, or a mixture of different organic and/or inorganic pigments and/or fillers. Component (A) may also be a dye, which in certain solvents is soluble and in other solvents has pigment character. The pigments may be used both in the form of dry powder and as water-moist presscakes.

Organic pigments contemplated include monoazo, disazo, laked azo, β-naphthol, naphthol AS, benzimidazolone, disazo condensation or azo-metal complex pigments and polycyclic pigments such as, for example, phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or a carbon blacks.

An illustrative selection of particularly preferred organic pigments includes carbon black pigments, such as gas blacks or furnace blacks; monoazo and disazo pigments, especially the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; 6-naphthol and naphthol AS pigments, especially the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, especially the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, especially the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, especially the Colour Index pigments Pigment Yellow 139 or Pigment Yellow 173; phthalocyanine pigments, especially the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, especially the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, especially the Colour Index pigments Pigment Red 169, Pigment Blue 56 or Pigment Blue 61; diketopyrrolopyrrole pigments, especially the Colour Index pigments Pigment Red 254, Pigment Red 255, Pigment Red 264, Pigment Red 270, Pigment Red 272, Pigment Orange 71, Pigment Orange 73, Pigment Orange 81.

Also suitable are laked dyes such as Ca, Mg and Al lakes of dyes containing sulfonic and/or carboxylic acid groups.

Suitable inorganic pigments are, for example, titanium dioxides, zinc sulfides, zinc oxides, iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed phase pigments, sulfides of the rare earths, spinels of cobalt with nickel and zinc, spinels based on iron and chromium with copper, zinc and manganese, bismuth vanadates, and also extender pigments. Use is made more particularly of the Colour Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33 and Pigment White 6. Preference is also often given to mixtures of inorganic pigments. Mixtures of organic with inorganic pigments are likewise frequently used.

Examples of suitable fillers are finely divided ores, minerals, and salts which are sparingly soluble or insoluble, such as, for example, carbonates, calcium carbonate, calcites and/or aragonites, dolomites, silicon dioxide, quartz, cristobalite, kieselguhr, silicates, aluminum silicates, silicas, talc, kaolin, mica, feldspar, and barium sulfate. Mixtures of fillers are also frequently used with preference. Mixtures of organic and/or inorganic pigments with fillers are likewise frequently used. Formulations which comprise exclusively one or more fillers are used, for example, to blend pigment preparations for the purpose of establishing the desired profile of properties, such as the pigment content, the rheology, density or compatibility, for instance.

The structural units (I) and (II) of component (B) are reaction products of alkoxylatable polyols having a hydricity of three or more, preferably diglycerol, erythritol, glycerol, pentaerythritol, polyglycerols, sorbitol, trimethylolpropane or xylitol. In one preferred embodiment Y is H or —PO₃M₂.

Examples of compounds used as component (C) include cationic, anionic, amphoteric or nonionic compounds which promote pigment wetting (wetting agents, wetted).

Serving as component (D) of the pigment preparations of the invention are customary dispersants and surfactants, or mixtures of such substances, that are suitable for producing aqueous pigment dispersions. Customarily used for this purpose are anionic, cationic, amphoteric or nonionic interface-active compounds. Particularly well-established among them are dispersants which possess one or more medium-chain or long-chain hydrocarbon chains, including in part those which possess aromatic ring groups. Of the multiplicity of compounds, mention will be made at this point only of a selection, without, however, limiting the applicability of the preparations of the invention to these examples. Examples are alkyl sulfates such as lauryl sulfate, steelyl sulfate or octadecyl sulfate, primary alkylsulfonates such as dodecylsulfonate, and secondary alkylsulfonates, especially C₁₃-C₁₇ alkanesulfonate sodium salt, alkyl phosphates, alkylbenzenesulfonates such as, for example, dodecylbenzenesulfonic acid, and also all salts of these compounds. Soy lecithin is also suitable, or condensation products of fatty acid and taurine or hydroxyethanesulfonic acid are used, as are alkoxylation products of castor oil rosin esters, fatty alcohols, fatty amines, fatty acids and fatty acid amides; these alkoxylation products may also be furnished with ionic end groups, in the form, for example, of sulfosuccinic monoesters or else of sulfonic, sulfuric and phosphoric esters, and also their salts, the sulfonates, sulfates or phosphates. Nonionic or anionically modified copolymers are also suitable, prepared using macromonomers of polyethylene/polypropylene glycol mono(meth)acrylic esters, and, in a similar way, nonionic or anionically modified, block-copolymeric, styrene oxide-containing polyalkylene oxides.

Corresponding to component (E) are organic solvents or hydrotropic substances. These may be, for example, the following compounds or a mixture thereof: mono- or polyhydric alcohols, their ethers and esters, e.g., alkanols, especially with 1 to 4 carbon atoms, such as methanol, ethanol, propanol, isopropanol, butanol, isobutanol; dihydric or trihydric alcohols, especially having 2 to 5 carbon atoms, e.g., ethylene glycol, propylene glycol, 1,3-propanediol, 1,4-butanediol, 1,5-pentanediol, 1,6-hexanediol, 1,2,6-hexanetriol, glycerol, diethylene glycol, dipropylene glycol, triethylene glycol, tripropylene glycol; lower alkyl ethers of polyhydric alcohols, such as ethylene glycol monomethyl, monoethyl or monobutyl ether, triethylene glycol monomethyl or monoethyl ether; ketones and ketone alcohols, such as acetone, methyl ethyl ketone, diethyl ketone, methyl isobutyl ketone, methyl pentyl ketone, cyclopentanone, cyclohexanone, diacetone alcohol; copolymers of ethylene glycol and propylene glycol; polyethylene glycol, especially with an average molar mass of 250 to 1000 g/mol; polypropylene glycol; lower alkyl ethers of polyethylene glycols, such as alpha-methyl-omega-hydroxy-polyethylene glycol ethers, especially having an average molar mass of 250 to 1000 g/mol.

Corresponding to component (F) are organic or inorganic binders and/or cobinders. These may be, for example, the following compounds or a mixture thereof: waterglass, especially sodium and potassium silicates of the formula Na₂O×n SiO₂ and/or K₂O×n SiO₂, in which n=2.8-3.5; silica sol; alkylsiliconates, especially of the general formula HO—[Si(R)(OM)—O—]ₙH, in which R is an alkyl radical having 1 to 8 carbon atoms (e.g. methyl, ethyl, n-propyl, isopropyl, n-butyl, isobutyl, tert-butyl) and M is a cation, especially of the alkali metals (e.g., lithium, sodium, potassium), and n is a number in the range from 1 to 6, such as sodium or potassium methylsiliconate; homopolymers and/or copolymers and also dispersions thereof comprising acrylates, alkyl acrylates, such as methacrylates, acrylic acid, methacrylic acid, ethylene, vinyl acetate and/or styrene.

Examples of components (G) employed are thickeners, preservatives, viscosity stabilizers and grinding assistants. Further customary adjuvants may be antisettling agents, light stabilizers, antioxidants, defoamers/degassers/deaerators, foam reducers, anticaking agents, and also additives which favorably influence the viscosity and rheology. Examples of suitable agents for regulating the viscosity include polyvinyl alcohol, polysaccharides, such as cellulose, microcrystalline or nanocrystalline cellulose, cellulose ethers and modified cellulose ethers, especially hydrophobically modified cellulose ethers, xanthan, pyrogenic silica, for example Aerosils, polyacrylate and/or polyurethane and/or polyurea thickeners, especially having molecular weights of 10³ to 10⁵ g/mol, clay minerals and phyllosilicates, especially those consisting of smectite, montmorillonite, hectorite and bentonite or mixtures thereof, and also organically modified and delaminated phyllosilicates. Water-soluble natural or synthetic resins and also polymers as film formers and/or binders for increasing adhesiveness and abrasion resistance are also contemplated. Organic or inorganic bases and acids are employed as pH regulators. Preferred inorganic bases are sodium, potassium or lithium hydroxide. Corresponding to component (G) may also be fats and oils of vegetable and animal origin, examples being bovine tallow, palm kernel fat, coconut fat, rapeseed oil, sunflower oil, linseed oil, palm oil, soy oil, peanut oil, cotton seed oil, corn oil, poppy oil, olive oil, castor oil, colza oil, safflower oil, soybean oil, thistle oil, sunflower oil, herring oil, sardine oil. Further common place additives include the saturated and unsaturated higher fatty acids, examples being palmitic acid, cyprylic acid, capric acid, myristic acid, lauric acid, stearic acid, oleic acid, linoleic acid, linolenic acid, caproic acid, caprylic acid, arachidic acid, behenic acid, palmitoleic acid, gadoleic acid, erucic acid and ricinoleic acid, and also their salts.

Water utilized for producing the pigment preparations, component (H), is used preferably in the form of distilled or demineralized water. Drinking water (mains water) and/or water of natural origin may also be used.

The pigment preparations of the invention are characterized in that they have a viscosity of <10 Pa*s at a shear rate of 5 s⁻¹, preferably of <8 Pa*s and more preferably of <6 Pa*s, and also a viscosity of <3 Pa*s at a shear rate of 30 s⁻¹, preferably of <2.5 Pa*s and more preferably of <2 Pa*s. The rheological profile of the pigment preparations of the invention here may typically be controlled through the selection of ratio of components (A) and (B). The additional use of components (C), (D) and (G) may also be utilized in order to achieve the aforesaid rheological profile.

Having emerged as being particularly advantageous in connection with the aqueous pigment preparations of the invention is their very high compatibility with a multiplicity of coating materials and binder systems, their low foaming tendency and good shear stability, and their great stability over a prolonged period. It has also proven very advantageous that the aqueous pigment preparations of the invention have a high color strength and, even at high pigment contents of >30 wt %, have the desired rheological profile and also an excellent storage stability.

Furthermore, the pigment preparations of the invention are free from alkylphenol, tristyrylphenol, novolac and bisphenol A derivatives.

The pigment preparations of the invention have a pH of 4-14, preferably of 6-13 and more preferably of 6.5-12.5.

Another subject of the present invention is a method for producing such pigment preparations, wherein component (A) is dispersed in the form of powder, granules or aqueous presscake in the presence of water (G) and also of components (B) and optionally (C), (D), (E) and (F), subsequently optionally water (G), and also optionally one or more of components (C), (D), (E) and (F), are mixed in, and optionally the resulting aqueous pigment dispersion is diluted with water (G).

The pigment and the dispersing assistants of the formula (I) or (II) or mixtures of the dispersants of the formulae (I) and (II) are finely divided or finely dispersed here by means of a dispersing assembly or combinations of different dispersing assemblies, preferably a dissolver (sawtooth stirrer) and/or a stirred ballmill, with exposure to metallic or nonmetallic grinding media having a diameter of less than or equal to 2 mm, in the presence of water. The rest of the adjuvants may be present during the fine division and/or added subsequently.

A further subject of the invention is the use of the pigment preparations of the invention as colorants for pigmenting and coloring natural and synthetic materials of all kinds, more particularly aqueous or solvent borne coating materials, binder systems, paints, emulsion paints and enamels (dispersion-based coating materials), glazes, lime paints, silicate paints, silicone resin paints, and renders. Coating materials in the sense of the present invention are intended to embrace compositions according to DIN EN ISO 4618:2015-01.

An additional subject of the invention is the use of the pigment preparations of the invention in tinting systems comprising A) at least one pigment preparation of the invention, preferably at least two pigment preparations of the invention, more preferably at least three pigment preparations of the invention, and B) at least one tinting base composition. The tinting base constitutes, for example, an emulsion paint, an enamel, a lime paint, a silicate paint, a silicone resin paint, a dispersion silicate paint, a plaster, a floor coating, a render, an aqueous glaze, a solvent borne glaze, a water-based varnish or a solvent-based varnish, or forms a basic formulation for the aforementioned systems.

In addition, the pigment preparations of the invention are suitable for coloring macromolecular materials of all kinds, examples being natural and synthetic fiber materials, sausage skins, seed, fertilizers, glass, insulating materials, such as glass wool, for example, concrete, wood stains, waxes, paraffins, drawing inks, ballpoint pen pastes, chalks, detergents, shoe care products, latex products, abrasives, in viscose dope dyeings and also for coloring plastics or high molecular materials of all kinds. Examples of high molecular organic materials are cellulose ethers and esters, such as ethylcellulose, nitrocellulose, cellulose acetate or cellulose butyrate, natural resins or synthetic resins, such as polymerization resins or condensation resins, e.g., amino resins, especially urea-formaldehyde and melamine-formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, latices, silicone, silicone resins, individually or in a mixture.

### EXAMPLES

Examples of the dispersants used in the pigment preparations of the invention are the following compounds:

| Specimen | Composition | Chemical structure |
|---|---|---|
| Specimen 1 | Pentaerythritol + 4 mol propylene oxide + 12 mol styrene oxide + 140 mol ethylene oxide | 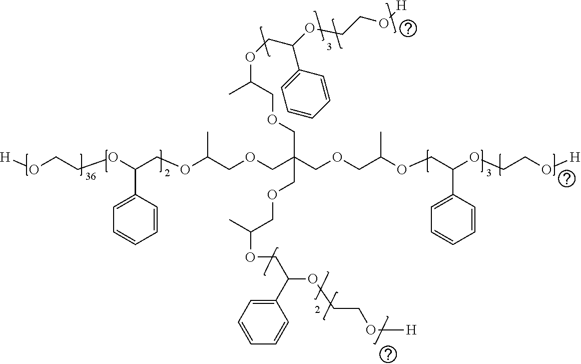 |
| Specimen 2 | Glycerol + 12 mol styrene oxide + 75 mol ethylene oxide | 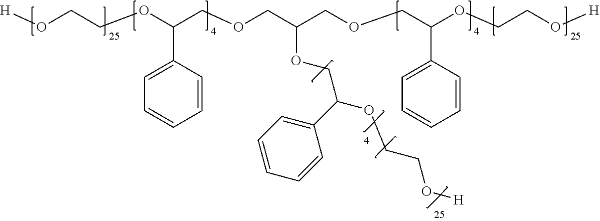 |
| Specimen 3 | Glycerol + 6 mol styrene oxide + 42 mol ethylene oxide | 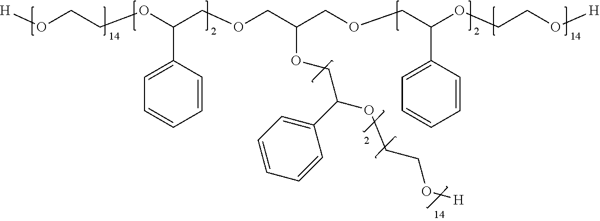 |
| Specimen 4 | Glycerol + 12 mol styrene oxide + 75 mol ethylene oxide + phosphate sodium salt | 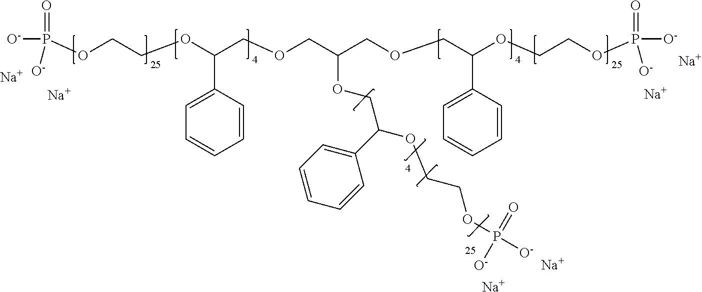 |
| Comparative specimen 1 | Ethylene diamine + 4 mol propylene oxide + 8 mol styrene oxide + 80 mol ethylene oxide | 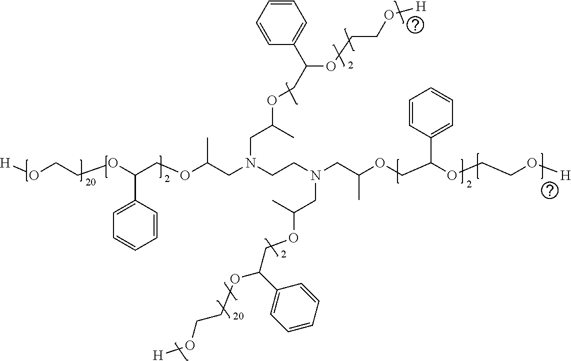 |

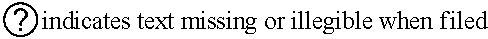

Production of a pigment preparation:

The pigment, either as powder, granules or presscakes, together with the dispersants and the other additions, was pasted in deionized water and then homogenized and predispersed with a dissolver (e.g., from VMAGetzmann GmbH, model AE3-M1) or another suitable apparatus. The subsequent fine dispersion took place using a beadmill (e.g., with AE3-M1 from VMA-Getzmann GmbH) or another suitable dispersing assembly, with grinding taking place using glass beads with a size d=1.0-1.2 mm, with cooling, until the desired coloristics were achieved. Thereafter the dispersion was adjusted with deionized water to the desired final pigment concentration, the grinding media was separated off, and the pigment preparation was isolated.

The pigment preparations described in the examples below were produced by the method described above, with the constituents being used in the stated quantities such that 100 parts of the respective pigment preparation were formed. In the examples below, parts mean parts by weight.

Assessment of a pigment preparation:

The color strength and shade were determined according to DIN 55986, by homogenizing a defined amount of the pigment preparation with an emulsion paint and then applying this tinted paint in a defined film thickness to a paint card. The coloristic properties of the dried film were analyzed using a spectrophotometer (e.g., CM-3700A bench-top spectrophotometer from Konica Minolta).

For determining the compatibility by the “rub-out” test, the emulsion paint or the varnish after mixing with the pigment dispersion was applied to a paint card. The lower part of the paint card was subsequently rubbed with the finger. Incompatibility was present when the rubbed area had a stronger color than the adjacent, untreated area (the rub-out test is described in DE 2 638 946). To assess the compatibility, six conventional aqueous and solvent borne coating systems with different compositions were employed, based on different standard commercial binders.

The viscosity was determined using a cone-and-plate viscometer (MCR 72) from Anton Paar GmbH, at 20° C. (titanium cone: ø60 mm, 1°), with the relationship between the viscosity and the shear rate being studied in a range between 0 and 200 s⁻¹.

For assessing the foam behavior of the preparation, a sample was first deaerated by centrifuge at 2000 rpm for 60 seconds, and the density of this deaerated sample (ρ_{deaerated}) was determined according to DIN EN ISO 2811-1 using a paint pycnometer (e.g., model 290 from Erichsen GmbH & Co. KG). The sample was subsequently shaken for 3 minutes in a 150 mL HDPE beaker (75% fill level) using a shaker (e.g., DAS 200-K disperser from Lau GmbH) at a shaking frequency of 660 rpm, and the density of this sample was again determined as described above (ρₛₕₐₖₑₙ). The ratio of the densities thus determined for the shaken and the deaerated sample, ρₛₕₐₖₑₙ/ρ_{deaerated}, ought to be >0.90.

For assessing the storage stability of the dispersions, the viscosity was measured directly after the preparation had been produced, and also after storage for 28 days at 50° C. In addition, the color strength of the sample thus stored was determined relative to a sample stored at room temperature. Moreover, the homogeneity and the sedimentation behavior of the stored sample were evaluated by determining the clear liquid phase and the sediment formed. The storage stability was rated “very good” if the viscosity of the stored sample at a shear rate of 60 s⁻¹ differed by <150 mPa*s from the viscosity measured directly after production, the color strength of the stored sample deviated by <3% from that of the sample stored at room temperature, and the stored sample showed no signs of sedimentation. The storage stability was rated “good” if the viscosity deviated by 150-300 mPa*s and/or the color strength deviated by 3-5%, and/or the stored sample showed slight signs of sedimentation, but could be completely rehomogenized by simple stirring. The storage stability was rated “poor” if the viscosity differed by >600 mPa*s and/or the color strength deviated by >7% and/or the stored sample exhibited severe sedimentation.

Testing for meterability in tinting machines took place by filling the designated colorant container of the machine (e.g., Harbil HA400 from Fast & Fluid) with 2-3 L of the test material and observing the metering results at regular intervals over a period of 4 weeks after initial calibration. The principal criteria for assessing suitability were the stability of the initial density of the test material, the stability of the calibration of the test material on the unit, the attainable precision and reproducibility in metering trials, and the visual appearance, especially in relation to foam and rheology.

The pigment preparations described in the examples below were produced according to the method described above, with the following constituents being used in the stated quantities in such a way that 100 parts of the respective pigment preparation were formed. In the examples below, parts denote parts by weight.

### Example 1

30.0 parts of component (A), C.I. Pigment Violet 023

8.0 parts of component (B), dispersant as per specimen 1

10.0 parts of component (E), propylene glycol

0.6 part of component (G), preservative

Balance of component (H), Wasser

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). After production, the preparation exhibits a virtually Newtonian rheology profile with a viscosity of <0.1 Pa*s over all shear rates in the range of 1-200 s⁻¹. The preparation is stable in storage and under shear.

### Example 2

45.0 parts of component (A), C.I. Pigment Blue 015:3

12.0 parts of component (B), dispersant as per specimen 2

7.5 parts of component (E), alpha-methyl-omega-hydroxy-polyethylene glycol ether, average molecular weight 500 g/mol

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency ρₛₕₐₖₑₙ/ρ_{deaerated}>0.95). The preparation after production has a viscosity of 2.30 Pa*s at a shear rate of 5 s⁻¹, 1.02 Pa*s at a shear rate of 30 s⁻¹, and 0.75 Pa*s at a shear rate of 60 s⁻¹. The preparation is stable in storage and under shear.

The pigment preparations based on C.I. Pigment Blue 015:3 that are described in DE 10 2006 002 800 do have a viscosity within the desired range, but their pigment content is only 30 wt %. Conversely, the pigment content in example 2 shown above is 45 wt %, corresponding to an increase in the pigment content by 50%, with no change in the good storage stability and viscosity.

### Example 3

40.0 parts of component (A), C.I. Pigment Blue 015:1

13.6 parts of component (B), dispersant as per specimen 2

9.0 parts of component (E), alpha-methyl-omega-hydroxy-polyethylene glycol ether, average molecular weight 500 g/mol

1.0 part of component (G), defoamer

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency ρₛₕₐₖₑₙ/ρ_{deaerated}>0.95). The preparation after production has a viscosity of 1.37 Pa*s at a shear rate of 5 s⁻¹, 0.67 Pa*s at a shear rate of 30 s⁻¹, and 0.51 Pa*s at a shear rate of 60 s⁻¹. The preparation is stable in storage and under shear. On tinting machines, the pigment preparation is highly meterable and is stable over a period of 4 weeks.

### Example 4

50.0 parts of component (A), C.I. Pigment Green 007

7.2 parts of component (B), dispersant as per specimen 2

0.7 part of component (D), sodium salt of a carboxymethylated alcohol polyglycol ether

10.0 parts of component (E), alpha-methyl-omega-hydroxy-polyethylene glycol ether, average molecular weight 500 g/mol

1.0 part of component (G), defoamer

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency ρₛₕₐₖₑₙ/ρ_{deaerated}>0.95). The preparation after production has a viscosity of 0.81 Pa*s at a shear rate of 5 s⁻¹, 0.54 Pa*s at a shear rate of 30 s⁻¹, and 0.45 Pa*s at a shear rate of 60 s⁻¹. The preparation is stable in storage and under shear.

### Example 5

41.0 parts of component (A), C.I. Pigment Yellow 074

9.6 parts of component (B), dispersant as per specimen 2

0.2 part of component (D), cetyltrimethylammonium chloride

11.0 parts of component (E), alpha-methyl-omega-hydroxy-polyethylene glycol ether, average molecular weight 500 g/mol

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency ρₛₕₐₖₑₙ/ρ_{deaerated}>0.95). The preparation after production has a viscosity of 0.80 Pa*s at a shear rate of 5 s⁻¹, 0.28 Pa*s at a shear rate of 30 s⁻¹, and 0.18 Pa*s at a shear rate of 60 s⁻¹. The preparation is stable in storage and under shear. On tinting machines, the pigment preparation is highly meterable and is stable over a period of 4 weeks.

### Example 6

38.0 parts of component (A), C.I. Pigment Yellow 097

8.0 parts of component (B), dispersant as per specimen 2

10.0 parts of component (E), alpha-methyl-omega-hydroxy-polyethylene glycol ether, average molecular weight 500 g/mol

2.0 parts of component (G), oleic acid

1.0 part of component (G), defoamer

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 0.74 Pa*s at a shear rate of 5 s⁻¹, 0.28 Pa*s at a shear rate of 30 s⁻¹, and 0.19 Pa*s at a shear rate of 60 s⁻¹. The preparation is stable in storage and under shear.

### Example 7

62.0 parts of component (A), C.I. Pigment Blue 028

3.2 parts of component (B), dispersant as per specimen 2

0.5 part of component (D), benzenesulfonic acid, 4-C 10-13-sec-alkyl derivatives

0.8 part of component (D), tetrasodium N-(1,2-dicarboxyethyl)-N-octadecylsulfosuccinamate

5.0 parts of component (D), fatty alcohol polyglycol ether

5.0 parts of component (E), ethylene oxide-propylene oxide copolymer (branched)

2.0 parts of component (G), oleic acid

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 4.84 Pa*s at a shear rate of 5 s⁻¹, 1.95 Pa*s at a shear rate of 30 s⁻¹, and 1.23 Pa*s at a shear rate of 60 s⁻¹. The preparation is stable in storage and under shear.

### Example 8

41.0 parts of component (A), C.I. Pigment Yellow 074

11.5 parts of component (B), dispersant as per specimen 3

0.2 part of component (D), cetyltrimethylammonium chloride

11.0 parts of component (E), alpha-methyl-omega-hydroxy-polyethylene glycol ether, average molecular weight 500 g/mol

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 4.10 Pa*s at a shear rate of 5 s⁻¹, 0.62 Pa*s at a shear rate of 30 s⁻¹, and 0.46 Pa*s at a shear rate of 60 s⁻¹. The preparation is stable in storage and under shear.

### Example 9

40.0 parts of component (A), C.I. Pigment Blue 015:3

8.0 parts of component (B), dispersant as per specimen 3

10.0 parts of component (E), propylene glycol

0.6 part of component (F), preservative

Balance of component (G), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 1.90 Pa*s at a shear rate of 5 s⁻¹, 0.43 Pa*s at a shear rate of 30 s⁻¹, and 0.28 Pa*s at a shear rate of 60 s⁻¹. The preparation is stable in storage and under shear.

The pigment preparations based on C.I. Pigment Blue 015:3 that are described in DE 10 2006 002 800 do have a viscosity within the desired range, but their pigment content is only 30 wt %. Conversely, the pigment content in example 9 shown above is 40 wt %, corresponding to an increase in the pigment content by >33%, with no change in the good storage stability and viscosity.

### Example 10

30.0 parts of component (A), C.I. Pigment Red 254

6.0 parts of component (B), dispersant as per specimen 4

1.5 parts of component (D), cocoamidopropyl betaine

5.0 parts of component (D), fatty alcohol polyglycol ether

12.5 parts of component (E), alpha-methyl-omega-hydroxy-polyethylene glycol ether, average molecular weight 500 g/mol

2.0 parts of component (G), oleic acid

1.0 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 0.42 Pa*s at a shear rate of 5 s⁻¹, 0.35 Pa*s at a shear rate of 30 s⁻¹, and 0.31 Pa*s at a shear rate of 60 s⁻¹. The preparation is stable in storage and under shear.

### Example 11

41.0 parts of component (A), C.I. Pigment Yellow 074

11.5 parts of component (B), dispersant as per specimen 4

11.0 parts of component (E), alpha-methyl-omega-hydroxy-polyethylene glycol ether, average molecular weight 500 g/mol

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 1.67 Pa*s at a shear rate of 5 s⁻¹, 0.44 Pa*s at a shear rate of 30 s⁻¹, and 0.28 Pa*s at a shear rate of 60 s⁻¹. The preparation is stable in storage and under shear.

### Example 12

43.0 parts of component (A), C.I. Pigment Black 007

18.0 parts of component (B), dispersant as per specimen 4

0.3 part of component (D), sulfosuccinic diester sodium salt

8.0 parts of component (E), alpha-methyl-omega-hydroxy-polyethylene glycol ether, average molecular weight 500 g/mol

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 1.85 Pa*s at a shear rate of 5 s⁻¹, 0.82 Pa*s at a shear rate of 30 s⁻¹, and 0.62 Pa*s at a shear rate of 60 s⁻¹. The preparation is stable in storage and under shear.

The pigment preparation based on C.I. Pigment Black 007 that is described in DE 10 2006 002 800 does have a viscosity within the desired range, but its pigment content is only 25 wt %. Conversely, the pigment content in example 12 shown above is 43 wt %, corresponding to an increase in the pigment content by 72%, with nevertheless good storage stability and viscosity.

### Example 13

70.0 parts of component (A), C.I. Pigment Red 101

5.0 parts of component (B), dispersant as per specimen 4

5.0 parts of component (D), fatty alcohol polyglycol ether

5.0 parts of component (E), ethylene oxide-propylene oxide copolymer (branched)

2.0 parts of component (G), oleic acid

0.9 part of component (G), preservative

Balance of component (H), water

The pigment preparation has a consistently high color strength and features broad compatibility without rub-out and also without formation of unwanted surface defects in six coating systems having different compositions. The preparation exhibits a very low foaming tendency (ρₛₕₐₖₑₙ/ρ_{deaerated}>0.95). The preparation after production has a viscosity of 6.83 Pa*s at a shear rate of 5 s⁻¹, 2.94 Pa*s at a shear rate of 30 s⁻¹, and 2.55 Pa*s at a shear rate of 60 s⁻¹. The preparation is stable in storage and under shear.

The pigment preparation based on C.I. Pigment Red 102 that is described in DE 10 2006 002 800 does have a viscosity within the desired range, but its pigment content is only 60 wt %. Conversely, the pigment content in example 13 shown above is 70 wt %, corresponding to an increase in the pigment content by >16%, with nevertheless good storage stability and viscosity.

### Comparative Example 1

41.0 parts of component (A), C.I. Pigment Yellow 074

10.0 parts of component (B), dispersant as per comparative specimen 1

0.2 part of component (D), cetyltrimethylammonium chloride

11.0 parts of component (E), alpha-methyl-omega-hydroxy-polyethylene glycol ether, average molecular weight 500 g/mol

0.9 part of component (G), preservative

Balance of component (H), water

The pigment preparation has a low color strength. Compared with example 5, the color strength is only 80%. The rub-out test shows an incompatibility in two out of six coating systems. The preparation is not storage-stable, since the color strength after storage for 28 days at 50° C. has fallen to 88% as compared with the color strength before storage. This can be attributed to insufficient pigment wetting and pigment stabilization.

### Comparative Example 2

45.0 parts of component (A), C.I. Pigment Blue 015:3

12.0 parts of component (B), dispersant as per comparative specimen 1

7.5 parts of component (E), alpha-methyl-omega-hydroxy-polyethylene glycol ether, average molecular weight 500 g/mol

0.9 part of component (G), preservative

Balance of component (H), water

The pigment preparation has a low color strength. Compared with example 2, the color strength is only 94%. The rub-out test shows a severe incompatibility in two and a slight incompatibility in one out of a total of six coating systems. The viscosity is 8.10 Pa*s at a shear rate of 5 s⁻¹, 2.21 Pa*s at a shear rate of 30 s⁻¹ and 1.52 Pa*s at a shear rate of 60 s⁻¹, compared with a viscosity of 2.30 Pa*s at a shear rate of 5 s⁻¹, 1.02 Pa*s at a shear rate of 30 s⁻¹ and 0.75 Pa*s at a shear rate of 60 s⁻¹ in example 2. This can be attributed to inadequate viscosity reduction and particle stabilization.

### Comparative Example 3

30.0 parts of component (A), C.I. Pigment Violet 023

8.0 parts of component (B), dispersant as per comparative specimen 1

10.0 parts of component (E), propylene glycol

0.6 part of component (G), preservative

Balance of component (H), water

The pigment preparation has a very low color strength. Compared with example 1, the color strength is only 90%.

| | | Pigment | | Viscosity | Viscosity | Viscosity | | | |
|---|---|---|---|---|---|---|---|---|---|
| | | content | Color | at 5 s⁻¹ | at 30 s⁻¹ | at 60 s⁻¹ | Compatibility with | Foam behavior/ | Storage |
| Example | C.I. | [wt %] | strength | [Pa*s] | [Pa*s] | [Pa*s] | binder systems | ρₛₕₐₖₑₙ/ρ_{deaerated} | stability |
| 1 | Pigment | 30 | very | <0.1 | <0.1 | <0.1 | no rub-out and no | very good/ | very |
| | Violet 023 | | good | | | | surface defects | >0.95 | good |
| | | | | | | | in 6 systems | | |
| 2 | Pigment | 45 | very | 2.30 | 1.02 | 0.75 | no rub-out and no | very good/ | very |
| | Blue 015:3 | | good | | | | surface defects | >0.95 | good |
| | | | | | | | in 6 systems | | |
| 3 | Pigment | 40 | very | 1.37 | 0.67 | 0.51 | no rub-out and no | very good/ | very |
| | Blue 015:1 | | good | | | | surface defects | >0.95 | good |
| | | | | | | | in 6 systems | | |
| 4 | Pigment | 50 | very | 0.81 | 0.54 | 0.45 | no rub-out and no | very good/ | very |
| | Green 007 | | good | | | | surface defects | >0.95 | good |
| | | | | | | | in 6 systems | | |
| 5 | Pigment | 41 | very | 0.80 | 0.28 | 0.18 | no rub-out and no | very good/ | good |
| | Yellow 074 | | good | | | | surface defects | >0.95 | |
| | | | | | | | in 6 systems | | |
| 6 | Pigment | 38 | very | 0.74 | 0.28 | 0.19 | no rub-out and no | very good/ | very |
| | Yellow 097 | | good | | | | surface defects | >0.95 | good |
| | | | | | | | in 6 systems | | |
| 7 | Pigment | 62 | very | 4.84 | 1.95 | 1.23 | no rub-out and no | very good/ | good |
| | Blue 028 | | good | | | | surface defects | >0.95 | |
| | | | | | | | in 6 systems | | |
| 8 | Pigment | 41 | very | 4.10 | 0.62 | 0.46 | no rub-out and no | very good/ | very |
| | Yellow 074 | | good | | | | surface defects | >0.95 | good |
| | | | | | | | in 6 systems | | |
| 9 | Pigment | 40 | very | 1.90 | 0.43 | 0.28 | no rub-out and no | very good/ | very |
| | Blue 015:3 | | good | | | | surface defects | >0.95 | good |
| | | | | | | | in 6 systems | | |
| 10 | Pigment | 30 | very | 0.42 | 0.35 | 0.31 | no rub-out and no | very good/ | very |
| | Red 254 | | good | | | | surface defects | >0.95 | good |
| | | | | | | | in 6 systems | | |
| 11 | Pigment | 41 | very | 1.67 | 0.44 | 0.28 | no rub-out and no | very good/ | very |
| | Yellow 074 | | good | | | | surface defects | >0.95 | good |
| | | | | | | | in 6 systems | | |
| 12 | Pigment | 43 | very | 1.85 | 0.82 | 0.62 | no rub-out and no | very good/ | very |
| | Black 007 | | good | | | | surface defects | >0.95 | good |
| | | | | | | | in 6 systems | | |
| 13 | Pigment | 70 | very | 6.83 | 2.94 | 2.55 | no rub-out and no | very good/ | very |
| | Red 101 | | good | | | | surface defects | >0.95 | good |
| | | | | | | | in 6 systems | | |
| Comp. 1 | Pigment | 41 | 80% vs. | n.d. | n.d. | 0.11 | severe rub-out | n.d. | poor, |
| | Yellow 074 | | Ex. 5 | | | | in 2 out of | | 12% loss in |
| | | | | | | | 6 systems | | color strength |
| | | | | | | | | | after storage |
| Comp. 2 | Pigment | 45 | 94% vs. | 8.10 | 2.21 | 1.52 | severe rub-out | n.d. | good |
| | Blue 015:3 | | Ex. 2 | | | | in 2 and slight | | |
| | | | | | | | rub-out in one | | |
| | | | | | | | of a total of | | |
| | | | | | | | 6 systems | | |
| Comp. 3 | Pigment | 30 | 90% vs. | <0.1 | <0.1 | <0.1 | no rub-out in | n.d. | n.d. |
| | Violet 023 | | Ex. 1 | | | | 6 systems | | |

1. Use of an aqueous pigment preparation for pigmenting natural or synthetic materials, the pigment preparation comprising
(A) at least one organic and/or inorganic pigment and/or filler
(B) at least one dispersant of the formula (I) or (II), or mixtures of the dispersants of the formulae (I) and (II), 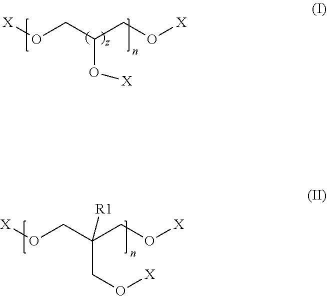
where
n is an integer greater than or equal to 1,
z is an integer greater than or equal to 1,
R1 is an aliphatic, linear or branched hydrocarbon radical having 1 to 30 carbon atoms, or a hydrogen atom, or the structural unit —O—X or the structural unit —CH₂—O—X,
and structural unit X corresponds to the formula (III) 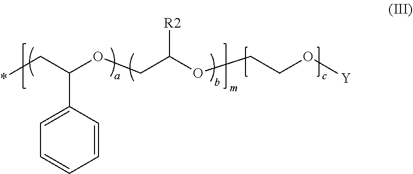
in which
a is an integer from 1 to 50, preferably 1 to 20, more preferably 1 to 10,
b is an integer from 0 to 50, preferably 0 to 20, more preferably 0 to 10,
c is an integer from 1 to 100, preferably 10 to 50,
m is an integer from 1 to 50, preferably 1 to 10,
R2 is an aliphatic, linear or branched hydrocarbon radical having 1 to 30 carbon atoms,
Y is —SO₃M, —SO₂M, —O₃M₂, —CH₂COOM, and
M is hydrogen or a cation, preferably from the group of Na⁺, K⁺, NH₄⁺, triethanolammonium, or a combination thereof,
and water,
wherein the pigment preparation is used in a tinting system as a coloring component, and
wherein the coloring of a tinting base, which is a liquid binder system present in white or transparent or chromatic form, is achieved by software-controlled metering of the pigment preparation.

2. The use as claimed in claim 1, wherein:
(C) one or more wetting agents,
(D) and/or further surfactants and/or dispersants,
(E) and/or one or more hydrotropic substances and/or one or more organic solvents and/or mixtures thereof,
(F) and/or one or more binders and/or cobinders,
(G) and/or further adjuvants customary for producing aqueous pigment dispersions, and
(H) optionally water
are employed.

3. The use as claimed in claim 1, comprising 5 to 80 wt % of component (A).

4. The use as claimed in claim 1, comprising 0.1 to 30 wt % of component (B).

5. The use as claimed in claim 1, comprising the following composition of components (A) to (H):
(A) 5 to 80 wt %, more particularly 10 to 70 wt %,
(B) 0.1 to 30 wt %, more particularly 2 to 20 wt %,
(C) 0 to 10 wt %, more particularly 0.1 to 5 wt %,
(D) 0 to 20 wt %, more particularly 1 to 10 wt %,
(E) 0 to 30 wt %, more particularly 5 to 20 wt %,
(F) 0 to 30 wt %, more particularly 1 to 10 wt %,
(G) 0 to 20 wt %, more particularly 0.1 to 5 wt %,
(H) balance water,
based in each case on the total weight (100 wt %) of the pigment preparation.

6. The use as claimed in claim 1, wherein the organic pigment of component (A) is a monoazo, disazo, laked azo, β-naphthol, naphthol AS, benzimidazolone, disazo condensation or azo-metal complex pigments or a polycyclic pigment from the group of the phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or a carbon black.

7. The use 2 as claimed in claim 1, wherein the structural units (I) and (II) of component (B) are reaction products of alkoxylatable polyols with a hydricity of three or higher, preferably diglycerol, erythritol, glycerol, pentaerythritol, polyglycerols, sorbitol, trimethylolpropane or xylitol.

8. The use as claimed in claim 1, wherein the pigment preparation possesses a viscosity of less than 10.0 Pa*s at a shear rate of 5 s⁻¹.

9. The use as claimed in claim 1, wherein the pigment preparation possesses a pH in the range of 4-14.

10-19. (canceled)

20. The use as claimed in claim 1, wherein the natural or synthetic material is a render or a concrete.

21. The use as claimed in claim 2, comprising 5 to 80 wt % of component (A).

22. The use as claimed in claim 2, comprising 0.1 to 30 wt % of component (B).

23. The use as claimed in claim 2, comprising the following composition of components (A) to (H):
(A) 5 to 80 wt %, more particularly 10 to 70 wt %,
(B) 0.1 to 30 wt %, more particularly 2 to 20 wt %,
(C) 0 to 10 wt %, more particularly 0.1 to 5 wt %,
(D) 0 to 20 wt %, more particularly 1 to 10 wt %,
(E) 0 to 30 wt %, more particularly 5 to 20 wt %,
(F) 0 to 30 wt %, more particularly 1 to 10 wt %,
(G) 0 to 20 wt %, more particularly 0.1 to 5 wt %,
(H) balance water,
based in each case on the total weight (100 wt %) of the pigment preparation.

24. The use as claimed in claim 2, wherein the organic pigment of component (A) is a monoazo, disazo, laked azo, β-naphthol, naphthol AS, benzimidazolone, disazo condensation or azo-metal complex pigments or a polycyclic pigment from the group of the phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or a carbon black.

25. The use as claimed in claim 24, wherein the structural units (I) and (II) of component (B) are reaction products of alkoxylatable polyols with a hydricity of three or higher, preferably diglycerol, erythritol, glycerol, pentaerythritol, polyglycerols, sorbitol, trimethylolpropane or xylitol.
